(19) United States
(12) Patent Application Publication
(10) Pub. No.: US 2024/0106104 A1
(43) Pub. Date: Mar. 28, 2024

(54) ELECTRONIC DEVICE AND ANTENNA MODULE

(71) Applicants: Hung-Yu Yeh, Taipei City (TW); Shih-Chia Liu, Taipei City (TW); Yen-Hao Yu, Taipei City (TW); Li-Chun Lee, Taipei City (TW); Chih-Heng Lin, Taipei City (TW); Jui-Hung Lai, Taipei City (TW)

(72) Inventors: Hung-Yu Yeh, Taipei City (TW); Shih-Chia Liu, Taipei City (TW); Yen-Hao Yu, Taipei City (TW); Li-Chun Lee, Taipei City (TW); Chih-Heng Lin, Taipei City (TW); Jui-Hung Lai, Taipei City (TW)

(73) Assignee: COMPAL ELECTRONICS, INC., Taipei City (TW)

(21) Appl. No.: 18/463,298

(22) Filed: Sep. 8, 2023

Related U.S. Application Data
(60) Provisional application No. 63/408,862, filed on Sep. 22, 2022.

(51) Int. Cl. H01Q 1/22; H01Q 1/52; H01Q 9/04; H01Q 13/10

(52) U.S. Cl. CPC H01Q 1/2266; H01Q 1/526; H01Q 9/0421; H01Q 13/106

(57) ABSTRACT

An electronic device includes a device body and an antenna module disposed in the device body and including a conductive structure and a coaxial cable including a core wire, a shielding layer wrapping the core wire, and an outer jacket wrapping the shielding layer. The conductive structure includes a structure body and a slot formed on the structure body and penetrating the structure body in a thickness direction of the structure body. A section of the shielding layer extends from the outer jacket and is connected to the structure body. A physical portion of the structure body and the section of the shielding layer are respectively located on two opposite sides of the slot in a width direction of the slot. A section of the core wire extends from the section of the shielding layer and overlaps the slot and the physical portion in the thickness direction.

### CROSS-REFERENCE TO RELATED APPLICATION

This application claims the priority benefit of U.S. provisional application Ser. No. 63/408,862, filed on Sep. 22, 2022. The entirety of the above-mentioned patent application is hereby incorporated by reference herein and made a part of this specification.

### BACKGROUND

### Technical Field

The disclosure relates to an electronic device and an electronic module thereof; more particularly, the disclosure relates to an electronic device and an antenna module thereof.

### Description of Related Art

In response to a prevailing design trend favoring narrow bezels for laptop screens, antennas are now no longer positioned at the top of the screens. Instead, in a laptop computer, the antennas are placed on both sides of a keyboard of a logic body. However, this placement presents some challenges. The limited space available outside a circuit board, a speaker, and battery components of the laptop imposes restrictions on an extension range of the antennas and a manner of grounding the antenna. As a result, this arrangement leads to an insufficient antenna radiation efficiency.

### SUMMARY

The disclosure provides an electronic device capable of installing an antenna module with good radiation efficiency within limited space.

The disclosure provides an antenna module which may be installed within limited space and may have good radiation efficiency.

In an embodiment of the disclosure, an electronic device including a device body and an antenna module is provided. The antenna module is disposed in the device body and includes a conductive structure and a coaxial cable. The conductive structure includes a structure body and a slot. The slot is formed on the structure body and penetrates the structure body in a thickness direction of the structure body. The coaxial cable includes a core wire, a shielding layer, and an outer jacket. The shielding layer wraps the core wire, and the outer jacket wraps the shielding layer. A section of the shielding layer extends out from the outer jacket and is connected to the structure body. A physical portion of the structure body and the section of the shielding layer are respectively located on two opposite sides of the slot in a width direction of the slot, and a section of the core wire extends out from the section of the shielding layer and overlaps the slot and the physical portion in the thickness direction.

In an embodiment of the disclosure, an antenna module including a conductive structure and a coaxial cable is provided. The conductive structure includes a structure body and a slot. The slot is formed on the structure body and penetrates the structure body in a thickness direction of the structure body. The coaxial cable includes a core wire, a shielding layer, and an outer jacket. The shielding layer wraps the core wire, and the outer jacket wraps the shielding layer. A section of the shielding layer extends out from the outer jacket and is connected to the structure body. A physical portion of the structure body and the section of the shielding layer are respectively located on two opposite sides of the slot in a width direction of the slot. A section of the core wire extends out from the section of the shielding layer and overlaps the slot and the physical portion in the thickness direction.

According to an embodiment of the disclosure, the electronic device further includes a keyboard bracket, where the conductive structure is a part of the keyboard bracket.

According to an embodiment of the disclosure, the electronic device further includes a keyboard bracket, where the conductive structure is assembled to the keyboard bracket.

According to an embodiment of the disclosure, the antenna module further includes a conductive connection member. The conductive connection member is disposed on the structure body, and the section of the shielding layer contacts the conductive connection member, so as to be connected to the structure body through the conductive connection member.

According to an embodiment of the disclosure, the slot is an open slot.

According to an embodiment of the disclosure, the slot is a closed slot.

According to an embodiment of the disclosure, the slot has a horizontal linear shape, a T shape, or a U shape.

According to an embodiment of the disclosure, the conductive structure, the section of the core wire, and the section of the shielding layer constitute a slot antenna or a planar inverted F antenna (PIFA).

According to an embodiment of the disclosure, the coaxial cable includes an inner insulation layer, and the inner insulation layer completely wraps the section of the core wire extended from the shielding layer.

According to an embodiment of the disclosure, in the width direction of the slot, the section of the shielding layer and the slot are spaced from each other by a distance.

In view of the above, in the antenna module provided in one or more embodiments of the disclosure, the core wire of the coaxial cable crosses the slot of the conductive structure, and the shielding layer of the coaxial cable is grounded to the conductive structure, thereby coupling and feeding energy into the conductive structure to resonate a required antenna mode. This simplified setup significantly reduces the space requirements for the antenna module and allows the placement of the antenna module with good radiation efficiency in a limited space.

To make the above more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a three-dimensional view illustrating an electronic device according to an embodiment of the disclosure.

FIG. 2 is a bottom view illustrating a partial structure of the electronic device depicted in FIG. 1.

FIG. 3 is a three-dimensional view illustrating some components in the electronic device depicted in FIG. 2.

FIG. 4 is a bottom view illustrating the antenna module depicted in FIG. 3.

FIG. 5 is a partial enlarged view illustrating the coaxial cable depicted in FIG. 4.

FIG. 6 illustrates a return loss of the coaxial cable depicted in FIG. 4.

FIG. 7 is a bottom view illustrating an antenna module according to another embodiment of the disclosure.

FIG. 8 is a bottom view illustrating an antenna module according to another embodiment of the disclosure.

FIG. 9 is a bottom view illustrating an antenna module according to another embodiment of the disclosure.

FIG. 10 is a bottom view illustrating a partial structure of an electronic device according to another embodiment of the disclosure.

FIG. 11 is a three-dimensional view illustrating the antenna module depicted in FIG. 10.

FIG. 12 is a bottom view illustrating a partial structure of an electronic device according to another embodiment of the disclosure.

FIG. 13 is a three-dimensional view illustrating the antenna module depicted in FIG. 12.

### DESCRIPTION OF THE EMBODIMENTS

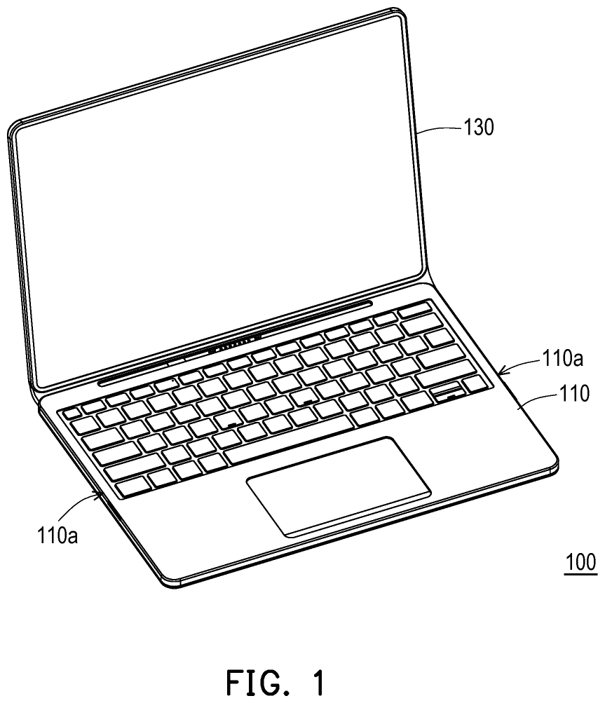

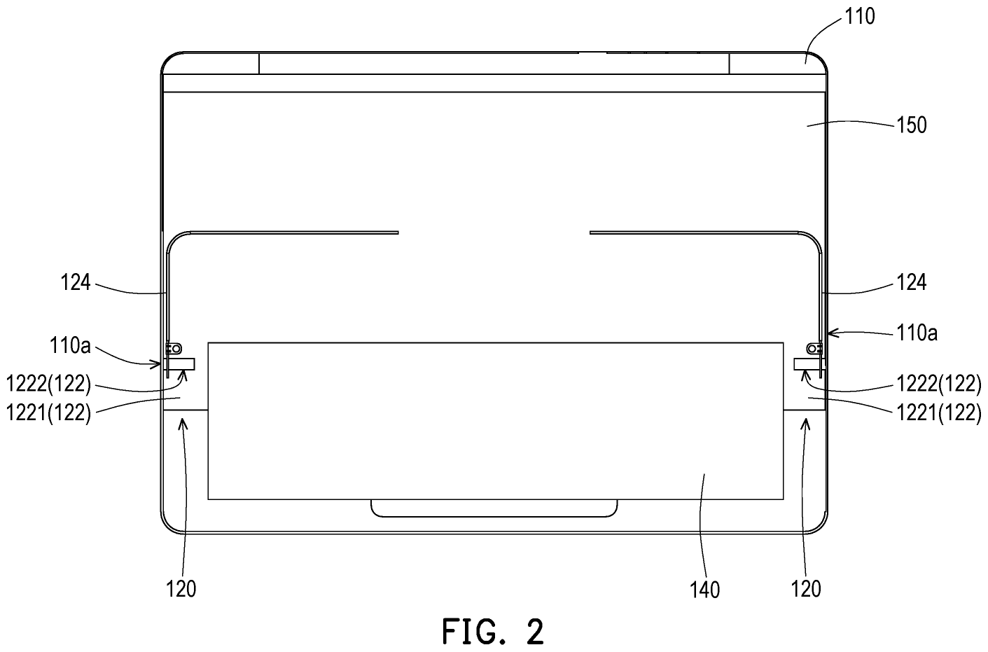

FIG. 1 is a three-dimensional view illustrating an electronic device according to an embodiment of the disclosure. FIG. 2 is a bottom view illustrating a partial structure of the electronic device depicted in FIG. 1. With reference to FIG. 1 and FIG. 2, an electronic device 100 provided in this embodiment includes a device body 110 and at least one antenna module 120 (shown as two). The antenna modules 120 are disposed in the device body 110 and are respectively adjacent to two opposite sides 110a of the device body 110.

In this embodiment, the electronic device 100 is, for instance, a laptop and further includes a screen 130 and a battery 140. The device body 110 is, for instance, a logic body of the laptop, the screen 130 is connected to the device body 110, and the battery 140 is disposed in the device body 110 and located between the two antenna modules 120. In other embodiments, the electronic device 100 may be other types of electronic products, and the number of the antenna modules 120 may be one or any other number, which should however not be construed as a limitation in the disclosure.

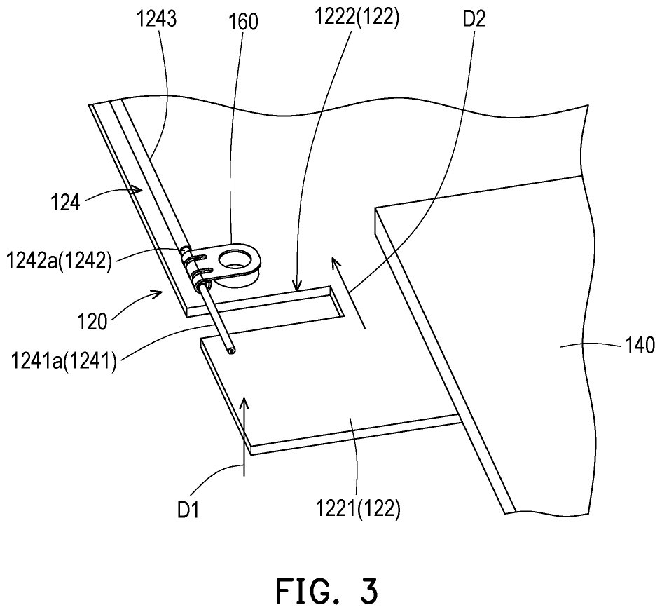

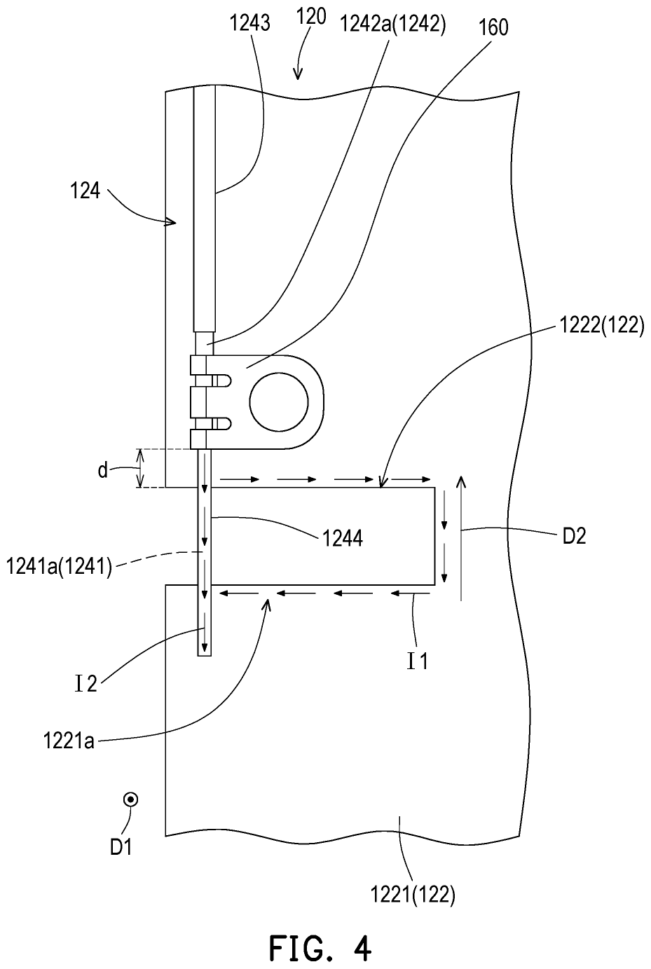

FIG. 3 is a three-dimensional view illustrating some components in the electronic device depicted in FIG. 2. FIG. 4 is a bottom view illustrating the antenna module depicted in FIG. 3. With reference to FIG. 3 and FIG. 4, the antenna module 120 provided in this embodiment includes a conductive structure 122 and a coaxial cable 124. The conductive structure 122 includes a structure body 1221 and a slot 1222. The slot 1222 is, for instance, an open slot with a horizontal linear shape and is formed in the structure body 1221 and penetrates the structure body 1221 in a thickness direction D1 of the structure body 1221. The coaxial cable 124 includes a core wire 1241, a shielding layer 1242, and an outer jacket 1243.

The shielding layer 1242 is, for instance, a metal woven mesh and wraps the core wire 1241, and the outer jacket 1243 wraps the shielding layer 1242. A section 1242a of the shielding layer 1242 extends out from the outer jacket 1243 and is connected to the structure body 1221. A physical portion 1221a of the structure body 1221 and the section 1242a of the shielding layer 1242 are respectively located on two opposite sides of the slot 1222 in a width direction D2 of the slot 1222. A section 1241a of the core wire 1241 extends out from the section 1242a of the shielding layer 1242 and overlaps the slot 1222 and the physical portion 1221a in the thickness direction D1 of the structure body 1221.

As described above, in the antenna module 120 provided in this embodiment, the core wire 1241 of the coaxial cable 124 crosses the slot 1222 of the conductive structure 122, and the shielding layer 1242 of the coaxial cable 124 is grounded to the conductive structure 122, thereby coupling and feeding energy into the conductive structure 122 to resonate the required antenna mode. This simplified setup significantly reduces the space requirements for the antenna module 120 and allows the placement of the antenna module 120 with good radiation efficiency in a limited space.

To be specific, the electronic device 100 provided in this embodiment further includes a keyboard bracket 150. The keyboard bracket 150 is, for instance, made of a conductive metal, and the conductive structure 122 is integrally connected to the keyboard bracket 150 as a part of the keyboard bracket 150. That is, the slot 1222 provided in this embodiment is not formed on an additional conductive component but formed on the existing keyboard bracket 150 of the electronic device 100. Thereby, it is not necessary to add any conductive component into the device body 110 for the setup of the antenna module 120, which saves the configuration space inside the device body 110 and simplifies the assembly of the antenna module 120.

In this embodiment, the antenna module 120 further includes a conductive connection member 160. The conductive connection member 160 is disposed on the structure body 1221 of the conductive structure 122, and a section 1242a of the shielding layer 1242 of the coaxial cable 124 contacts the conductive connection member 160, so as to be connected to the structure body 1221 of the conductive structure 122 through the conductive connection member 160. Specifically, the conductive connection member 160 is, for instance, a metal clip and is screw fastened to the structure body 1221 of the conductive structure 122. Moreover, the conductive connection member 160 is, for instance, connected to the section 1242a of the shielding layer 1242 in a lap joint manner or welded to the section 1242a of the shielding layer 1242. In other embodiments, the conductive connection member 160 may be another conductive component of any other type, which should however not be construed as a limitation in the disclosure.

In this embodiment, in the width direction D2 of the slot 1222, the section 1242a of the shielding layer 1242 and the slot 1222 are spaced from each other by a distance d (indicated in FIG. 4). By changing the distance d, an overlapping length between the section 1241a of the core wire 1241 and the conductive structure 122 may be adjusted, whereby impedance matching of the antenna module 120 may be accomplished.

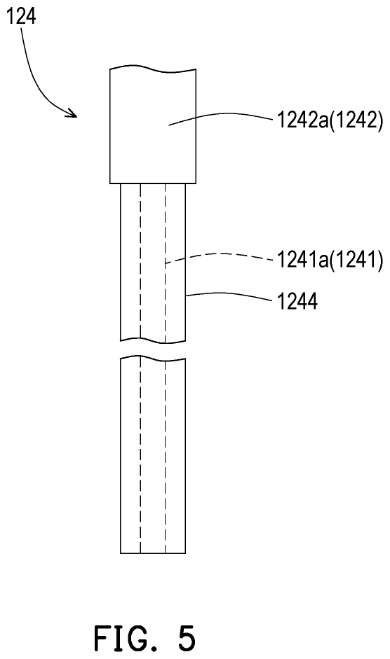

FIG. 5 is a partial enlarged view illustrating the coaxial cable depicted in FIG. 4. With reference to FIG. 4 and FIG. 5, the coaxial cable 124 provided in this embodiment further includes an inner insulation layer 1244, and a material of the inner insulation layer is, for instance, Teflon. The inner insulation layer 1244 completely wraps the section 1241a of the core wire 1241 extended from the shielding layer 1242. Thereby, the core wire 1241 may be prevented from unexpectedly making electrical contact with the conductive structure 122.

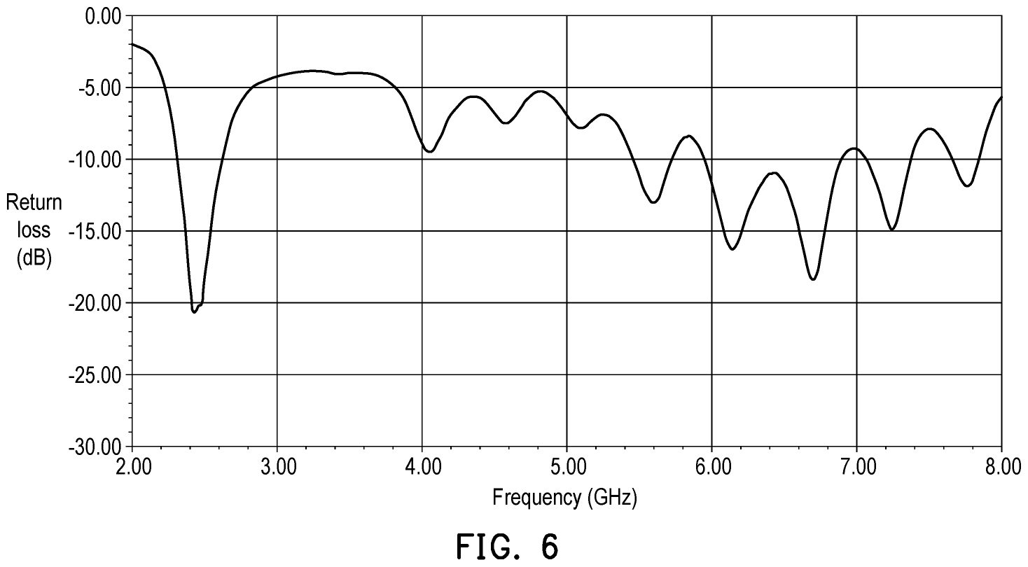

In this embodiment, the conductive structure 122, the section 1241a of the core wire 1241, and the section 1242a of the shielding layer 1242, for instance, constitute a slot antenna. A perimeter of the slot 1222 is, for instance, one-sixth to one-fourth the wavelength of a first resonance frequency band (for instance, 2.4 GHz), and the length of the section 1241a of the core wire 1241 is, for instance, one-sixth to one-fourth the wavelength of a central frequency of a second resonance frequency band (for instance, 6 GHz), so that the antenna module 120 is suitable for receiving and transmitting wireless signals with the first resonance frequency band and wireless signals with the second resonance frequency band. The second resonance frequency band may include WIFI 5 GHz and WIFI 6E bands. A current I1 of the first resonance frequency band, for instance, flows around an edge of the slot 1222 as shown in FIG. 4, and a current I2 of the second resonance frequency band, for instance, flows along the section 1241a of the core wire 1241 as shown in FIG. 4. FIG. 6 illustrates a return loss of the coaxial cable depicted in FIG. 4. As shown in FIG. 6, the return loss of the antenna module 120 has good performance at the first resonance frequency band and the second resonance frequency band.

The types of the conductive structure and the slot are not limited herein and are exemplified below.

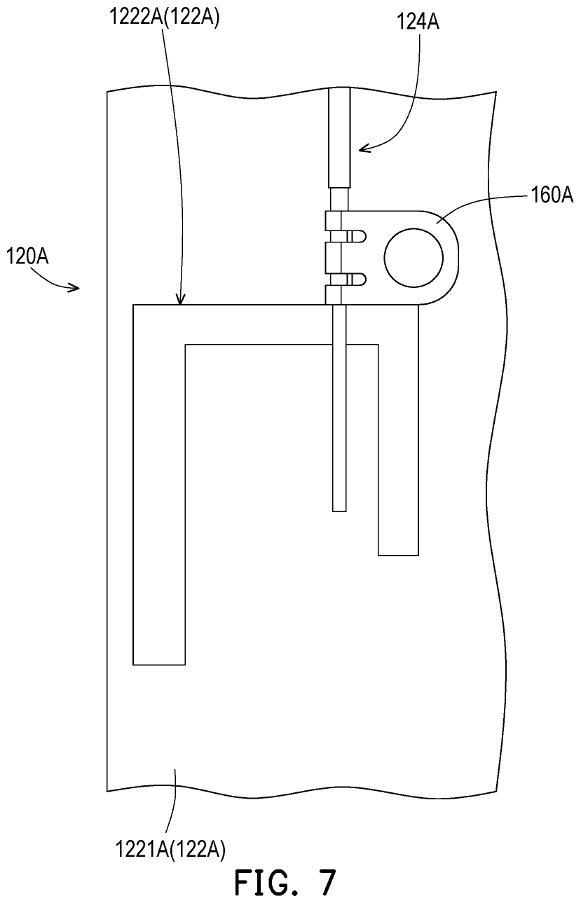

FIG. 7 is a bottom view illustrating an antenna module according to another embodiment of the disclosure. In an antenna module 120A depicted in FIG. 7, the configuration and the operation mode of a conductive structure 122A, a structure body 1221A, a coaxial cable 124A, and a conductive connection member 160A are the same or similar to the configuration and the operation mode of the conductive structure 122, the structure body 1221, the coaxial cable 124, and the conductive connection member 160 in FIG. 4 and thus are not elaborated hereinafter. The difference between the antenna module 120A in FIG. 7 and the antenna module in FIG. 4 lies in that a slot 1222A of the antenna module 120A is a closed slot with a U shape.

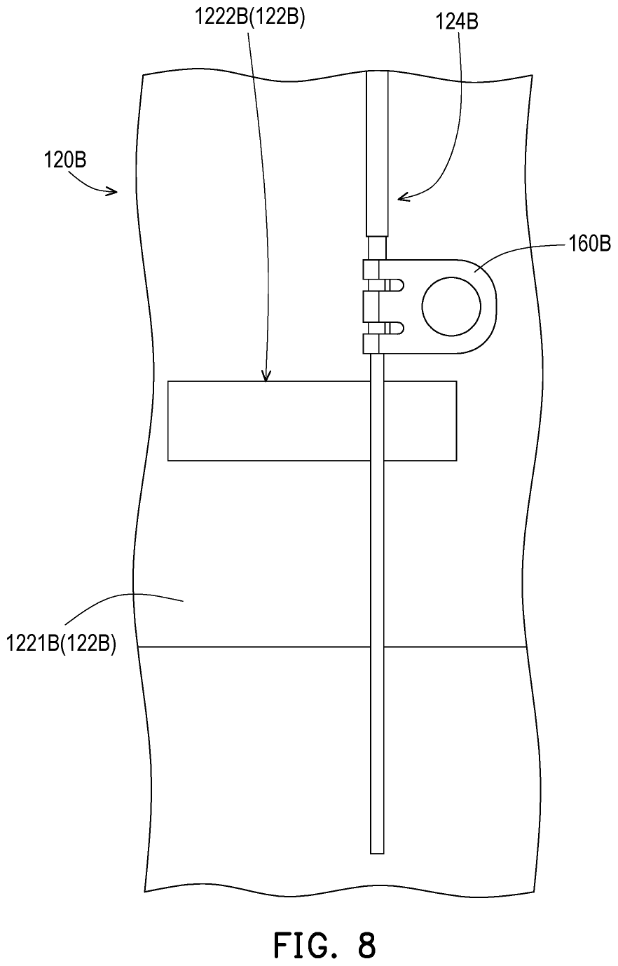

FIG. 8 is a bottom view illustrating an antenna module according to another embodiment of the disclosure. In an antenna module 120B depicted in FIG. 8, the configuration and the operation mode of a conductive structure 122B, a structure body 1221B, a coaxial cable 124B, and a conductive connection member 160B are the same or similar to the configuration and the operation mode of the conductive structure 122, the structure body 1221, the coaxial cable 124, and the conductive connection member 160 in FIG. 4 and thus are not elaborated hereinafter. The difference between the antenna module 120B in FIG. 8 and the antenna module in FIG. 4 lies in that the slot 1222B of the antenna module 120B is a closed slot with a horizontal linear shape.

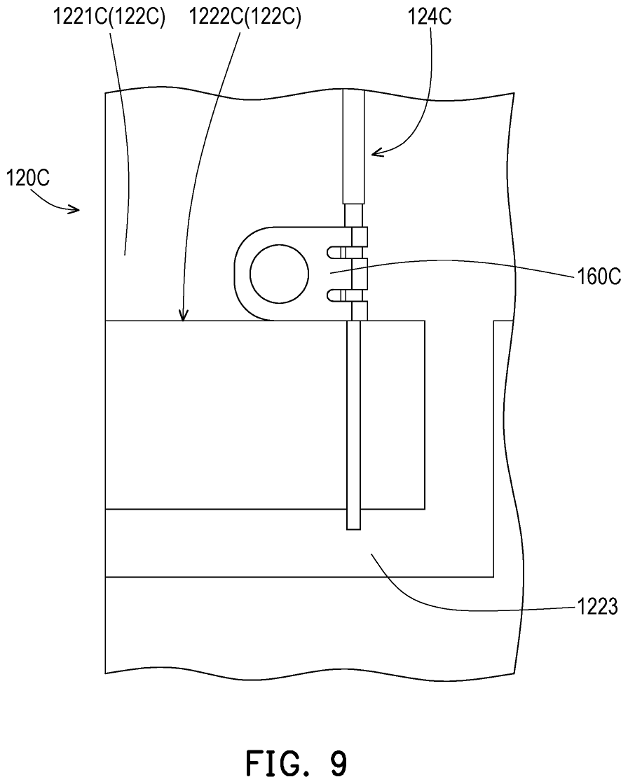

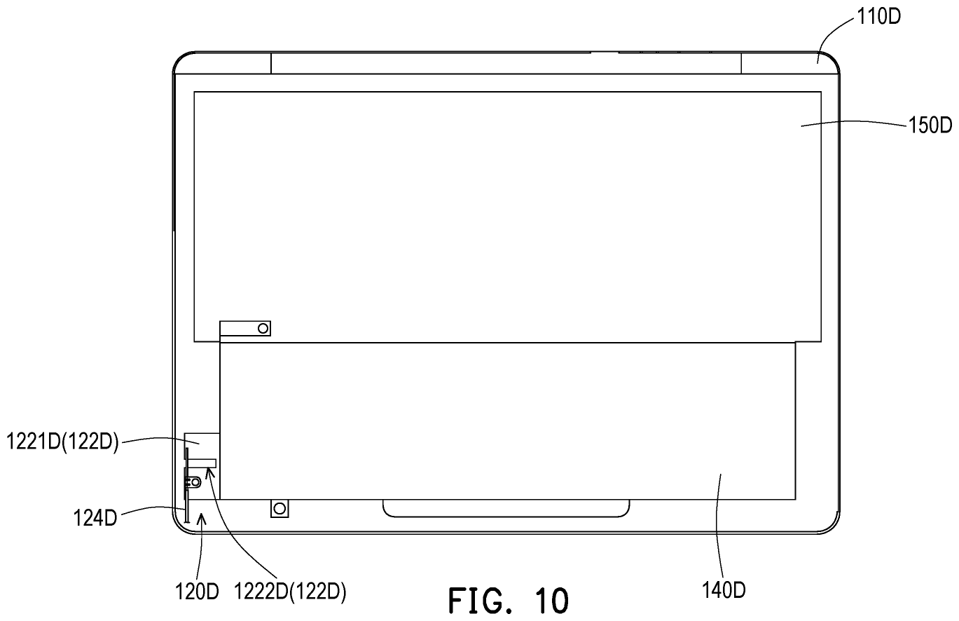

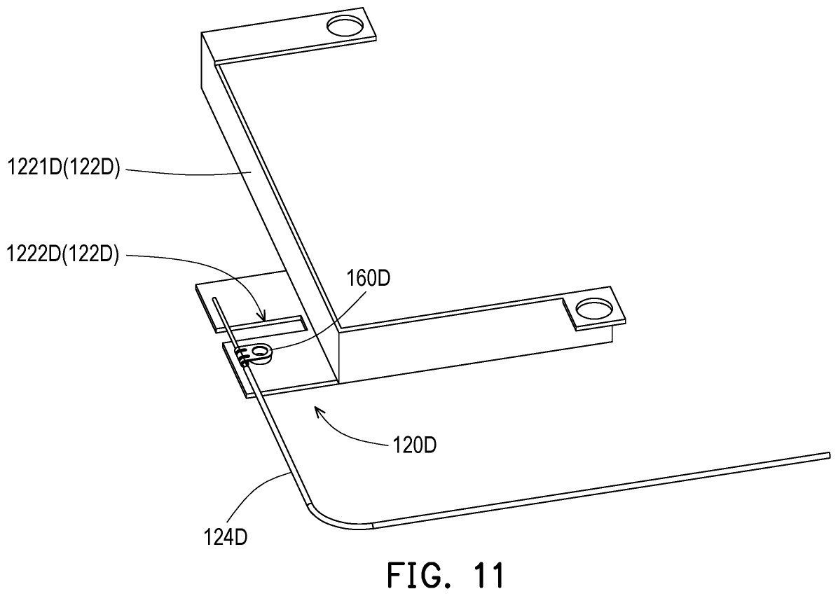

FIG. 9 is a bottom view illustrating an antenna module according to another embodiment of the disclosure. In an antenna module 120C depicted in FIG. 9, the configuration and the operation mode of a conductive structure 122C, a structure body 1221C, a coaxial cable 124C, and a conductive connection member 160C are the same or similar to the configuration and the operation mode of the conductive structure 122, the structure body 1221, the coaxial cable 124, and the conductive connection member 160 in FIG. 4 and thus are not elaborated hereinafter. The difference between the antenna module 120C in FIG. 9 and the antenna module in FIG. 4 lies in that the slot 1222C of the antenna module 120C is defined by an L-shaped structure 1223 extending out from the structure body 1221C, and the L-shaped structure 1223 of the conductive structure 122C and the coaxial cable 124C constitute a planar inverted F antenna (PIFA). An extension length of the L-shaped structure 1223 is, for instance, a quarter of the wavelength of the first resonance frequency band (for instance, 2.4 GHz). FIG. 10 is a bottom view illustrating a partial structure of an electronic device according to another embodiment of the disclosure. FIG. 11 is a three-dimensional view illustrating the antenna module depicted in FIG. 10. In the embodiment shown in FIG. 10 and FIG. 11, the configuration and the operation mode of a device body 110D, an antenna module 120D, a conductive structure 122D, a structure body 1221D, a slot 1222D, a coaxial cable 124D, a conductive connection member 160D, a battery 140D, and a keyboard bracket 150D are the same or similar to the configuration and the operation mode of the device body 110, the antenna module 120, the conductive structure 122, the structure body 1221, the slot 1222, the coaxial cable 124, the conductive connection member 160, the battery 140, and the keyboard bracket 150 in FIG. 2 and thus are not elaborated hereinafter. The difference between the embodiment shown in FIG. 10 and FIG. 11 and the embodiment shown in FIG. 2 lies in that the conductive structure 122D and the keyboard bracket 150D in FIG. 10 and FIG. 11 are not integrally formed. The conductive structure 122D, for instance, is a stamped iron piece and is assembled to the keyboard bracket 150D by screw fastening or other appropriate methods.

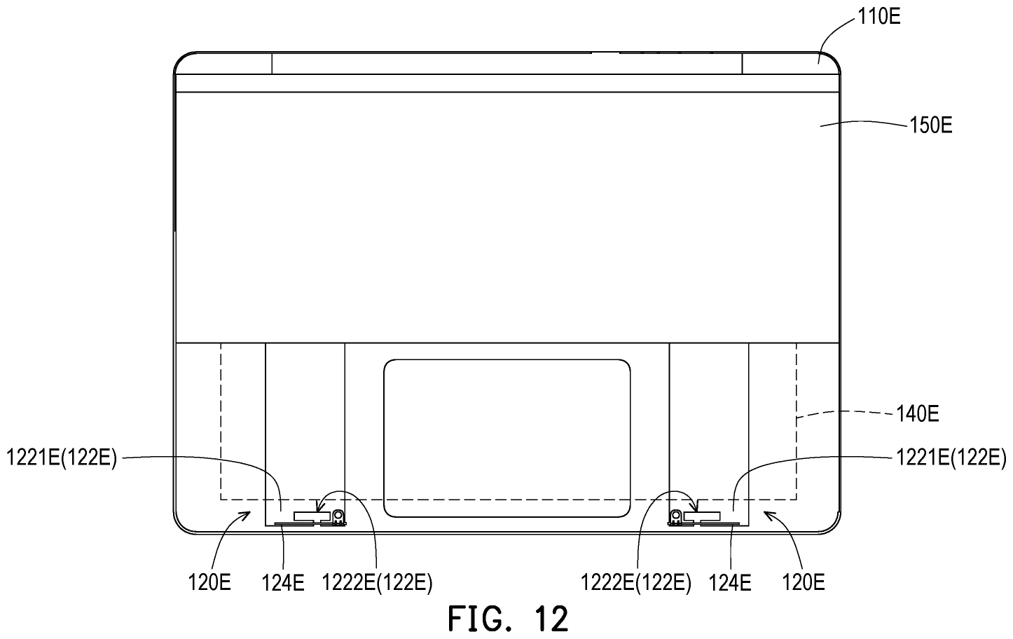

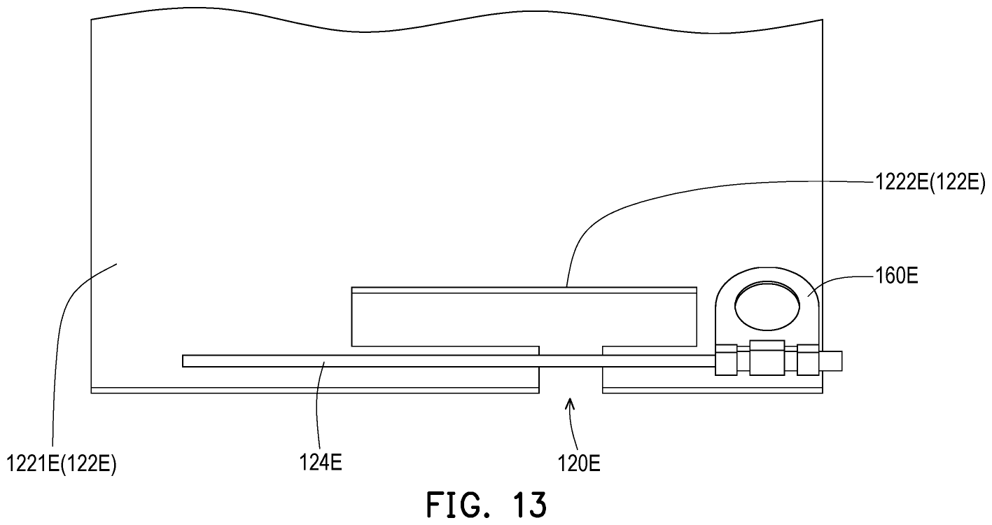

FIG. 12 is a bottom view illustrating a partial structure of an electronic device according to another embodiment of the disclosure. FIG. 13 is a three-dimensional view illustrating the antenna module depicted in FIG. 12. In the embodiment shown in FIG. 12 and FIG. 13, the configuration and the operation mode of a device body 110E, an antenna module 120E, a conductive structure 122E, a structure body 1221E, a slot 1222E, a coaxial cable 124E, a conductive connection member 160E, a battery 140E, and a keyboard bracket 150E are the same or similar to the configuration and the operation mode of the device body 110, the antenna module 120, the conductive structure 122, the structure body 1221, the slot 1222, the coaxial cable 124, the conductive connection member 160, the battery 140, and the keyboard bracket 150 in FIG. 2 and thus are not elaborated hereinafter. The difference between the embodiment shown in FIG. 12 and FIG. 13 and the embodiment shown in FIG. 2 lies in that the conductive structure 122E and the keyboard bracket 150E in FIG. 12 and FIG. 13 are not integrally formed. The conductive structure 122E, for instance, is an aluminum foil or a copper foil and is assembled to the keyboard bracket 150E by adhesion or other appropriate methods. In addition, the slot 1222E in FIG. 12 and FIG. 13 is an open slot with a T shape.

To sum up, in the antenna module provided in one or more embodiments of the disclosure, the core wire of the coaxial cable crosses the slot of the conductive structure, and the shielding layer of the coaxial cable is grounded to the conductive structure, thereby coupling and feeding energy into the conductive structure to resonate the required antenna mode. This simplified setup significantly reduces the space requirements for the antenna module configuration and allows the placement of the antenna module with good radiation efficiency within a limited space. In addition, the slot may be formed on the existing keyboard bracket of the electronic device rather than being formed on an additional conductive component. As such, it is not necessary to add any conductive component into the device body for the setup of the antenna module, thus saving the configuration space within the device body and simplifying the assembly of the antenna module.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. An electronic device, comprising:
a device body; and
an antenna module, disposed in the device body and comprising:
a conductive structure, comprising a structure body and a slot, wherein the slot is formed on the structure body and penetrates the structure body in a thickness direction of the structure body; and
a coaxial cable, comprising a core wire, a shielding layer, and an outer jacket, wherein the shielding layer wraps the core wire, the outer jacket wraps the shielding layer, a section of the shielding layer extends out from the outer jacket and is connected to the structure body, a physical portion of the structure body and the section of the shielding layer are respectively located on two opposite sides of the slot in a width direction of the slot, and a section of the core wire extends out from the section of the shielding layer and overlaps the slot and the physical portion in the thickness direction.

2. The electronic device according to claim 1, further comprising a keyboard bracket, wherein the conductive structure is a part of the keyboard bracket.

3. The electronic device according to claim 1, further comprising a keyboard bracket, wherein the conductive structure is assembled to the keyboard bracket.

4. The electronic device according to claim 1, wherein the antenna module further comprises a conductive connection member, the conductive connection member is disposed on the structure body, and the section of the shielding layer contacts the conductive connection member, so as to be connected to the structure body through the conductive connection member.

5. The electronic device according to claim 1, wherein the slot is an open slot.

6. The electronic device according to claim 1, wherein the slot is a closed slot.

7. The electronic device according to claim 1, wherein the slot has a horizontal linear shape, a T shape, or a U shape.

8. The electronic device according to claim 1, wherein the conductive structure, the section of the core wire, and the section of the shielding layer constitute a slot antenna or a planar inverted F antenna.

9. The electronic device according to claim 1, wherein the coaxial cable comprises an inner insulation layer, and the inner insulation layer completely wraps the section of the core wire extended from the shielding layer.

10. The electronic device according to claim 1, wherein in the width direction of the slot, the section of the shielding layer and the slot are spaced from each other by a distance.

11. An antenna module, comprising:
a conductive structure, comprising a structure body and a slot, wherein the slot is formed on the structure body and penetrates the structure body in a thickness direction of the structure body,
a coaxial cable, comprising a core wire, a shielding layer, and an outer jacket, wherein the shielding layer wraps the core wire, the outer jacket wraps the shielding layer, a section of the shielding layer extends out from the outer jacket and is connected to the structure body, a physical portion of the structure body and the section of the shielding layer are respectively located on two opposite sides of the slot in a width direction of the slot, and a section of the core wire extends out from the section of the shielding layer and overlaps the slot and the physical portion in the thickness direction.

12. The antenna module according to claim 11, wherein the conductive structure is a part of a keyboard bracket.

13. The antenna module according to claim 11, wherein the conductive structure is assembled to a keyboard bracket.

14. The antenna module according to claim 11, further comprising a conductive connection member, wherein the conductive connection member is disposed on the structure body, and the section of the shielding layer contacts the conductive connection member, so as to be connected to the structure body through the conductive connection member.

15. The antenna module according to claim 11, wherein the slot is an open slot.

16. The antenna module according to claim 11, wherein the slot is a closed slot.

17. The antenna module according to claim 11, wherein the slot has a horizontal linear shape, a T shape, or a U shape.

18. The antenna module according to claim 11, wherein the conductive structure, the section of the core wire, and the section of the shielding layer constitute a slot antenna or a planar inverted F antenna.

19. The antenna module according to claim 11, wherein the coaxial cable comprises an inner insulation layer, and the inner insulation layer wraps completely wraps the section of the core wire extended from the shielding layer.

20. The antenna module according to claim 11, wherein in the width direction of the slot, the section of the shielding layer and the slot are spaced from each other by a distance.
